(19) United States
(12) Patent Application Publication
(10) Pub. No.: US 2006/0086472 A1
(43) Pub. Date: Apr. 27, 2006

(54) Soft durable paper product

(75) Inventors: Michael Alan Hermans, Neenah, WI (US); Mike Thomas Goulet, Neenah, WI (US); Mark John Hassman, Appleton, WI (US); Jeffrey Janne Johnson, Neenah, WI (US); Jeffrey Dean Lindsay, Appleton, WI (US); Rebecca Catherine Mohr, Appleton, WI (US); Maurizio Tirimacco, Appleton, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/975,796

(22) Filed: Oct. 27, 2004

(51) Int. Cl. B31F 1/12; D21F 11/00

(52) U.S. Cl. 162/111; 162/123; 162/134; 162/204; 162/127; 428/156

(57) ABSTRACT

Soft durable paper towels are disclosed. These paper towels can be produced, for example, using a throughdried basesheet, such as an uncreped throughdried sheet, in which both outer surfaces have been pattern-printed with a binder and at least one outer surface of the sheet is creped.

### BACKGROUND OF THE INVENTION

Manufacturers of paper towels continually strive to improve various characteristics of their products. While considerable attention has been given to absorbent characteristics, the durability of the product, particularly when wet, has been overlooked. Therefore there is a need to provide a paper towel that has high wet durability, yet remains soft in the user's hand.

### SUMMARY OF THE INVENTION

It has now been discovered that a soft, durable-when-wet paper towel can be made by providing an uncreped throughdried paper towel basesheet and thereafter applying a post treatment which includes a patterned application of a binder to both outer surfaces of the uncreped throughdried basesheet in combination with one or more creping steps. To attain the desired wet characteristics, a number of variables in both the basesheet process and the post-treatment process must work together. These include the formation of a layered sheet with a chemical debonder in the central area of the sheet, the use of one or two rush transfers and the level of rush transfer, throughdrying the sheet, the application of a binder to both outer surfaces of the sheet and the use of creping to soften the sheet. The durability of the product can particularly be characterized by the wet cross-machine direction tensile energy absorbed (“wet CD TEA”, hereinafter defined), while the softness can be characterized by the wet cross-machine direction tensile slope (“wet CD Slope”, hereinafter defined). The strength and durability of the products of this invention can be further characterized by the wet cross-machine direction tensile strength (“wet CD tensile strength”), the dry geometric mean tensile strength (“GMT”) and the wet cross-machine direction stretch (“wet CD stretch”), all hereinafter defined. The softness can be further characterized by the dry cross-machine direction tensile slope (“dry CD Slope”, hereinafter defined).

Hence in one aspect, the invention resides in a paper towel having a wet CD TEA of about 12 g-cm/cm² or greater and a wet CD Slope of about 5 kilograms or less per 3 inches (76.2 mm).

In another aspect, the invention resides in a method of making a paper towel sheet comprising:(a) depositing an aqueous suspension of papermaking fibers onto a forming fabric to form a layered web having two outer layers and one or more inner layers, the inner layer(s) of the web containing from about 1 to about 10 kilograms of a chemical debonding agent per ton of fiber; (b) rush-transferring the web from the forming fabric to a transfer fabric; (c) transferring the web from the transfer fabric to a throughdrying fabric; (d) throughdrying the web to a final dryness of from about 1 to about 5 percent moisture; (e) feeding the resulting sheet to a gravure printing line wherein a binder is printed onto one outer surface of the sheet; (f) printing a binder onto the other outer surface of the sheet; (g) pressing the sheet against a rotating creping drum with a presser roll such that the sheet does not adhere to the presser roll; (h) creping the sheet from the creping drum; and (i) converting the sheet into a paper towel.

The wet CD TEA for the paper towels of this invention can be about 12 gram-centimeters per square centimeter (g-cm/cm²) or greater, more specifically about 13 g-cm/cm² or greater, more specifically about 14 g-cm/cm² or greater, more specifically from about 12 to about 18 g-cm/cm², and still more specifically from about 12 to about 14 g-cm/cm².

The wet CD Slope for the paper towels of this invention can be about 5 kilograms (force) or less per 3 inches (76.2 mm) (hereinafter simply referred to as “kilograms” or “kg”), more specifically about 4 kilograms or less, more specifically about 3 kilograms or less, still more specifically from about 1 to about 5 kilograms, and still more specifically from about 1 to about 4 kilograms.

In addition, the paper towels of this invention can have a dry CD Slope of about 6 kilograms (force) or less per 3 inches (76.2 mm) (hereinafter simply referred to as “kilograms” or “kg”), more specifically about 5 kilograms or less, more specifically about 4 kilograms or less, still more specifically from about 2 to about 6 kilograms, and still more specifically from about 2 to about 5 kilograms.

In addition, the paper towels of this invention can have a wet CD tensile strength of about 700 grams or greater per 3 inches (76.2 mm) (hereinafter simply referred to as “grams” or,“g”), more specifically about 800 grams or greater, more specifically from about 700 to about 1000 grams, still more specifically from about 750 to about 950 grams.

In addition, the paper towels of this invention can have a wet CD stretch of about 14 percent or greater, more specifically about 18 percent or greater, more specifically from about 14 to about 18 percent and still more specifically from about 15 to about 17 percent.

In addition, the paper towels of this invention can have a GMT of about 1900 grams or less per 3 inches (76.2 mm)(hereinafter simply referred to as “grams” or “g”), more specifically about 1700 grams or less, more specifically from about 1400 to about 1900 grams and still more specifically from about 1500 to about 1700 grams.

The paper towel sheets of this invention can be formed without a substantial amount of inner fiber-to-fiber bond strength. In this regard, the fiber furnish used to form the base web can be treated with a chemical debonding agent. The chemical debonding agent can be added to the fiber slurry during or after the fiber re-pulping process or can be added directly into the head box. Suitable chemical debonding agents that may be used in the present invention include cationic debonding agents such as fatty dialkyl quaternary ammonium salts, mono fatty alkyl tertiary amine salts, imidazoline quaternary salts, silicone quaternary salt and unsaturated fatty alkyl amine salts.

In one embodiment, the chemical debonding agent is an imidazolinium quaternary ammonium compound. Examples of suitable imidazolinium compounds include ProSoft® TQ1003, marketed by Hercules Incorporated, or C-6092, marketed by Goldschmidt Chemical Corporation.

The chemical debonding agent can be added to the fiber furnish according to a process as disclosed in PCT Application having an International Publication No. WO 99/34057 filed on December 17, 1998 or in PCT Published Application having an International Publication No. WO 00/66835 filed on Apr. 28, 2000, which are both incorporated herein by reference. In the foregoing publications, a process is disclosed in which a chemical debonding agent is adsorbed onto cellulosic papermaking fibers at high levels. The process includes the steps of treating a fiber slurry with an excess of the chemical additive, allowing sufficient residence time for adsorption to occur, filtering the slurry to remove unadsorbed chemical additives, and redispersing the filtered pulp with fresh water prior to forming a nonwoven web.

The amount of chemical debonding agent added to the fibers of the inner layer(s) can be from about 1 to about 10 kilograms per metric tonne (kg/MT), more specifically from about 2 to about 7 kilograms per metric tonne.

The degree of rush transfer, which is the speed differential between the forming fabric and the transfer fabric as the web is transferred from the forming fabric to the transfer fabric (and/or the speed differential between the transfer fabric and the throughdrying fabric), can be from about 5 to about 45 percent, and more specifically from about 10 to about 30 percent, and still more specifically from about 15 to about 25 percent.

The papermaking fabrics useful for purposes of this invention may have any suitable Air Permeability. As used herein, the “Air Permeability” may be measured with the FX 3300 Air Permeability device manufactured by Textest AG (Zürich, Switzerland), set to a pressure of 125 Pa with the normal 7-cm diameter opening (38 square centimeters area), which gives readings of Air Permeability in cubic feet per minute (CFM).

Papermaking fabrics suitable for use as transfer fabrics include, without limitation, fabrics having an Air Permeability of about 100 CFM or greater, more specifically about 300 CFM or greater, such as from about 300 CFM to about 1100 CFM, or from about 400 CFM to about 900 CFM. Suitable woven transfer fabrics, by way of example only, may have from 20 to 75 machine-direction filaments per inch (20 to 75 “mesh”) and from 15 to 60 cross-direction filaments per inch (15 to 60 “count”). Suitable transfer fabrics include those described in U.S. Pat. No. 5,607,551, issued to Farrington et al. on Mar. 4, 1997 and U.S. Pat. No. 5,645,112, issued Jul. 8, 1997.to Lee et al., both of which are herein incorporated by reference.

Papermaking fabrics suitable for use as throughdrying fabrics include, without limitation, fabrics having an Air Permeability of about 300 CFM or greater, more specifically about 400 CFM or greater, such as from about 400 CFM to about 1100 CFM, or from about 600 CFM to about 1000 CFM. Suitable woven transfer fabrics, by way of example only, may have from 15 to 70 machine-direction filaments per inch (15 to 70 “mesh”) and from 12 to 65 cross-direction filaments per inch (12 to 65 “count”). Particularly suitable throughdrying fabrics include those described in U.S. Pat. No. 5,429,686, issued to Chiu et al. on Jul. 4, 1995; U.S. Pat. No. 5,607,551, issued to Farrington et al. on Mar. 4, 1997; and U.S. Pat. No. 5,839,479, issued Nov. 24, 1998 to Gulya et al., all of which are herein incorporated by reference.

Suitable binders include, without limitation, latex binder materials such as acrylates, vinyl acetates, vinyl chlorides and methacrylates and the like. The binders may be created or blended with any suitable cross-linker, such as N-Methylolacrylamide (NMA), or may be free of cross-linkers. Particular examples of latex binder materials that can be used in the present invention include AIRFLEX® EN1165 available from Air Products Inc. or ELITE® PE BINDER available from National Starch. It is believed that both of the foregoing binder materials are ethylene vinyl acetate copolymers. Other suitable binders include, without limitation, carboxylated ethylene vinyl acetate terpolymer; acrylics; polyvinyl chloride; styrene-butadiene; polyurethanes; silicone materials, such as curable silicone resins, organoreactive polysiloxanes and other derivatives of polydimethylsiloxane; fluoropolymers, such as tetrafluoroethylene; hydrophobic coacervates or coplexes of anionic and cationic polymers, such as complexes of polyvinylamines and polycarboxylic acids; polyolefins and emulsions or compounds thereof; and many other film-forming compounds known in the art, as well as modified versions of the foregoing materials. The binder materials can be substantially latex-free or substantially natural latex-free in some embodiments.

The surface area coverage of the binder is discontinuous in the sense that it is not a solid film in order to allow liquid or moisture to penetrate into the sheet. It can be present in the form of a regularly or irregularly spaced-apart pattern of uniform or non-uniform deposits, such as provided by printing or a thinly-applied spray, for example. For each of the two outer surfaces of the product, the percent surface area coverage of the binder, as projected in a plan view of the surface, can be from about 10 to about 70 percent, more specifically from about 10 to about 60 percent, more specifically from about 15 to about 60 percent, more specifically from about 20 to about 60 percent, and still more specifically from about 25 to about 50 percent. The surface area coverage of each outer surface can be the same or different. As used herein, “surface area coverage” refers to the percent of the total area covered by the binder when measuring at least 6 square inches (38.7 square centimeters) of the web.

The total add-on amount of the binder, based on the weight of the product, can be about 2 weight percent or more, more specifically from about 2 to about 20 dry weight percent, more specifically from about 4 to about 9 dry weight percent, still more specifically from about 5 to about 8 dry weight percent. The add-on amount can be affected by the desired surface area coverage and the penetration depth of the deposits. The add-on amount applied to each outer surface of the product can be the same or different. The latex binder applied to different sheet surfaces can be the same or different.

The number of plies or sheets in the paper towels of this invention can be one, two three, four, five or more. For economy, single-ply or two-ply products are advantageous. The various plies within any given multi-ply product can be the same or different. By way of example, the various plies can contain different fibers, different chemicals, different basis weights, or be made differently to impart different topography or pore structure.

The fibers used to form the sheet or plies useful for purposes of this invention can be substantially entirely hardwood kraft or softwood kraft fibers, or blends thereof. However, other fibers can also be used for part of the furnish, such as sulfite pulp, mechanical pulp fibers, bleached chemithermomechanical pulp (BCTMP) fibers, synthetic fibers, pre-crosslinked fibers, non-woody plant fibers, and the like. More specifically, by way of example, the fibers can be from about 50 to about 100 percent softwood kraft fibers, more specifically from about 60 to about 100 percent softwood kraft fibers, still more specifically from about 70 to about 100 percent softwood kraft fibers, still more specifically from about 80 to about 100 percent softwood kraft fibers, and still more specifically from about 90 to about 100 percent softwood kraft fibers.

The basis weight of the products of this invention, whether single-ply or multiple-ply, can be from about 30 to about 90 gsm (grams per square meter), more specifically from about 40 to about 80 gsm, still more specifically from about 45 to about 75 gsm, and still more specifically from about 50 to about 70 gsm.

Creping of the basesheet can be carried out by any suitable means after the first or second or both applications of binder to the sheet. In general, the sheet is creped by being pressed against and adhered to the surface of a rotating creping roll and then being dislodged by contact with a creping blade. This results in a controlled pattern creping operation on one or both sides of the sheet. Any known creping blade may be used, such as blades made of steel, ceramic, or other materials. The blades may be substantially uniform or nonuniform, such as serrated blades.

### Test Methods

The “machine direction tensile strength” (MD tensile strength) is the peak load per 3 inches (76.2 mm) of sample width when a sample is pulled to rupture in the machine direction. Similarly, the “cross-machine direction tensile strength” (CD tensile strength) is the peak load per 3 inches (76.2 mm) of sample width when a sample is pulled to rupture in the cross-machine direction. The “geometric mean tensile strength” (GMT) is the square root of the product of the MD tensile strength multiplied by the CD tensile strength. All of the tensile strength parameters can be measured wet or dry.

Samples for dry tensile strength testing are prepared by cutting a 3 inches (76.2 mm) wide by 5 inches (127 mm) long strip in either the machine direction (MD) or cross-machine direction (CD) orientation using a JDC Precision Sample Cutter (Thwing-Albert Instrument Company, Philadelphia, Pa., Model No. JDC 3-10, Serial No. 37333). The instrument used for measuring tensile strengths is an MTS Systems Sintech 11S, Serial No. 6233. The data acquisition software is MTS TestWorks® for Windows Ver. 3.10 (MTS Systems Corp., Research Triangle Park, N.C.). The load cell is selected from either a 50 Newton or 100 Newton maximum, depending on the strength of the sample being tested, such that the majority of peak load values fall between10-90% of the load cell's full scale value. The gauge length between jaws is 4+/−0.04 inches (101.6+/−1 mm). The jaws are operated using pneumatic-action and are rubber coated. The minimum grip face width is 3 inches (76.2 mm), and the approximate height of a jaw is 0.5 inches (12.7 mm). The crosshead speed is 10+/−0.4 inches/min (254+/−1 mm/min), and the break sensitivity is set at 65%. The sample is placed in the jaws of the instrument, centered both vertically and horizontally. The test is then started and ends when the specimen breaks. The peak load is recorded as either the “MD tensile strength” or the “CD tensile strength” of the specimen depending on direction of the sample being tested. At least six (6) representative specimens are tested for each product or sheet and the arithmetic average of all individual specimen tests is either the MD or CD tensile strength for the product or sheet.

Wet tensile strength measurements are measured in the same manner, but are only typically measured in the cross-machine direction of the sample. Prior to testing, the center portion of the CD sample strip is saturated with tap water immediately prior to loading the specimen into the tensile test equipment. CD wet tensile measurements can be made immediately after the product is made. Sample wetting is performed by first laying a single test strip onto a piece of blotter paper (Fiber Mark, Reliance Basis 120). A pad is then used to wet the sample strip prior to testing. The pad is a Scotch-Brite® brand (3M) general purpose commercial scrubbing pad. To prepare the pad for testing, a full-size pad is cut approximately 2.5 inches (63.5 mm) long by 4 inches (101.6 mm) wide. A piece of masking tape is wrapped around one of the 4 inch (101.6 mm) long edges. The taped side then becomes the “top” edge of the wetting pad. To wet a tensile strip, the tester holds the top edge of the pad and dips the bottom edge in approximately 0.25 inch (6.35 mm) of tap water located in a wetting pan. After the end of the pad has been saturated with water, the pad is then taken from the wetting pan and the excess water is removed from the pad by lightly tapping the wet edge three times on a wire mesh screen. The wet edge of the pad is then gently placed across the sample, parallel to the width of the sample, in the approximate center of the sample strip. The pad is held in place for approximately one second and then removed and placed back into the wetting pan. The wet sample is then immediately inserted into the tensile grips so the wetted area is approximately centered between the upper and lower grips. The test strip should be centered both horizontally and vertically between the grips. (It should be noted that if any of the wetted portion comes into contact with the grip faces, the specimen must be discarded and the jaws dried off before resuming testing.) The tensile test is then performed and the peak load recorded as the CD wet tensile strength of this specimen. As with the dry tensile tests, the characterization of a product is determined by the average of at least six representative sample measurements.

In addition to measuring the tensile strengths, the “tensile energy absorbed” (TEA) is also reported by the MTS TestWorks® for Windows Ver. 3.10 program for each sample tested. “CD TEA” is reported in the units of grams-centimeters/centimeters squared (g-cm/cm²) and is defined as the integral of the force produced by a specimen with its elongation in the cross-machine direction up to the defined break point (65% drop in peak load) divided by the face area of the specimen.

The “tensile slope” (either the MD Slope or the CD Slope) is the average slope of the load/elongation curve for the tensile test described above measured over the range of 70-150 grams (force).

### BRIEF DESCRIPTION OF THE DRAWINGS

FIG. 1 is a schematic illustration of an uncreped throughdried paper making process suitable for purposes of making basesheet plies in accordance with this invention.

FIG. 2A is a schematic illustration of a print-print-crepe method of applying binder to the basesheet made in accordance with the process of FIG. 1.

FIG. 2B is a schematic illustration of a print-crepe-print-crepe method of applying binder to the basesheet made in accordance with the process of FIG. 1.

FIG. 3 is a representation of a binder pattern (dot pattern) applied to one side of the basesheet in the Examples.

FIG. 4 is a representation of a binder pattern (hexagonal element pattern) applied to the opposite side of the basesheet in the Examples.

FIG. 5 is a representation of an alternative binder pattern (reticulated pattern) that can be applied to the basesheet.

### DETAILED DESCRIPTION OF THE DRAWINGS

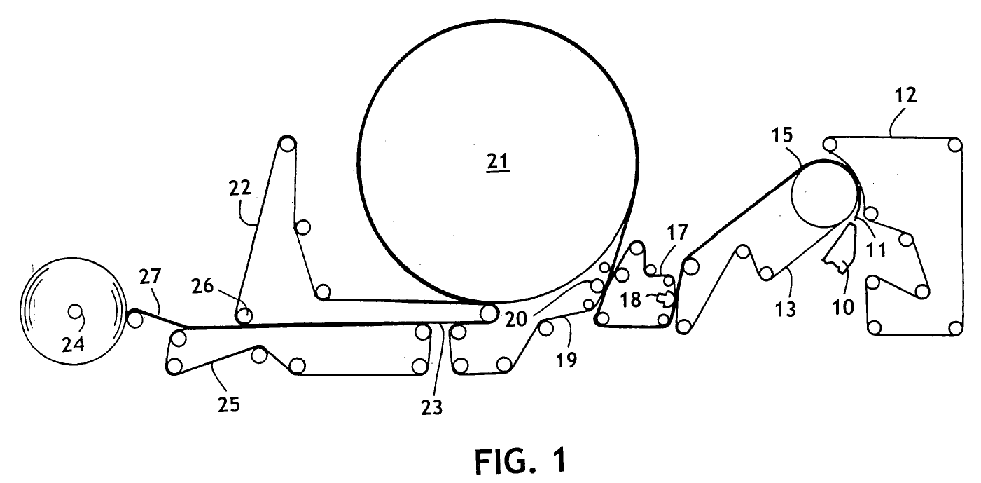

FIG. 1 is a schematic illustration of an uncreped throughdried process useful for making basesheets suitable for purposes of this invention. Shown is a twin wire former 8 having a papermaking headbox 10 which injects or deposits a stream 11 of an aqueous suspension of papermaking fibers onto a plurality of forming fabrics, such as the outer forming fabric 12 and the inner forming fabric 13, thereby forming a wet tissue web 15. The forming process of the present invention may be any conventional forming process known in the papermaking industry. Such formation processes include, but are not limited to, Fourdrinier formers, roof formers such as suction breast roll formers, and gap formers such as twin wire formers and crescent formers.

The wet tissue web 15 forms on the inner forming fabric 13 as the inner forming fabric 13 revolves about a forming roll 14. The inner forming fabric 13 serves to support and carry the newly-formed wet tissue web 15 downstream in the process as the wet tissue web 15 is partially dewatered to a consistency of about 10 percent based on the dry weight of the fibers. Additional dewatering of the wet tissue web 15 may be carried out by known paper making techniques, such as vacuum suction boxes, while the inner forming fabric 13 supports the wet tissue web 15. The wet tissue web 15 may be additionally dewatered to a consistency of at least about 20%, more specifically between about 20% to about 40%, and more specifically about 20% to about 30%. The wet tissue web 15 is then transferred from the inner forming fabric 13 to a transfer fabric 17 traveling preferably at a slower speed than the inner forming fabric 13 in order to impart increased MD stretch into the wet tissue web 15. The rush transfer is maintained at an appropriate level to ensure the right combination of stretch and strength in the finished product. Depending on the fabrics utilized and the post-tissue-machine converting process, the rush transfer should be in the range of from about 10 to about 25 percent.

The wet tissue web 15 is then transferred from the transfer fabric 17 to a throughdrying fabric 19 whereby the wet tissue web 15 may be macroscopically rearranged to conform to the surface of the throughdrying fabric 19 with the aid of a vacuum transfer roll 20 or a vacuum transfer shoe like the vacuum shoe 18. If desired, the throughdrying fabric 19 can be run at a speed slower than the speed of the transfer fabric 17 to further enhance MD stretch of the resulting absorbent sheet. The transfer may be carried out with vacuum assistance to ensure conformation of the wet tissue web 15 to the topography of the throughdrying fabric 19.

While supported by the throughdrying fabric 19, the wet tissue web 15 is dried to a final consistency of about 94 percent or greater by a throughdryer 21 and is thereafter transferred to a carrier fabric 22. Alternatively, the drying process can be any non-compressive drying method that tends to preserve the bulk of the wet tissue web 15.

The dried tissue web 23 is transported to a reel 24 using a carrier fabric 22 and an optional carrier fabric 25. An optional pressurized turning roll 26 can be used to facilitate transfer of the dried tissue web 23 from the carrier fabric 22 to the carrier fabric 25. If desired, the dried tissue web 23 may additionally be embossed to produce a pattern on the absorbent tissue product produced using the throughdrying fabric 19 and a subsequent embossing stage.

Once the wet tissue web 15 has been non-compressively dried, thereby forming the dried tissue web 23, it is possible to crepe the dried tissue web 23 by transferring the dried tissue web 23 to a Yankee dryer prior to reeling, or using alternative foreshortening methods such as micro-creping as disclosed in U.S. Pat. No. 4,919,877 issued on Apr. 24, 1990 to Parsons et al., herein incorporated by reference.

In an alternative embodiment not shown, the wet tissuec web 15 may be transferred directly from the inner forming fabric 13 to the throughdrying fabric 19, thereby eliminating the, transfer fabric 17. The throughdrying fabric 19 may be traveling at a speed less than the inner forming fabric 13 such that the wet tissue web 15 is rush transferred or, in the alternative, the throughdrying fabric 19 may be traveling at substantially the same speed as the inner forming fabric 13.

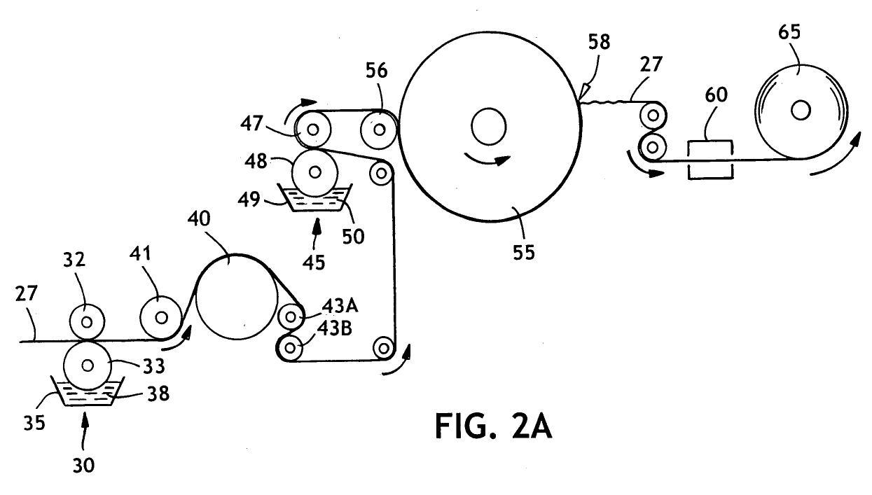

FIG. 2A is a schematic representation of a process in which a binder is applied to both outer surfaces of the uncreped throughdried basesheet as produced in accordance with FIG. 1. Although gravure printing of the binder is illustrated, other means of applying the binder can also be used, such as foam application, spray application, flexographic printing, or digital printing methods such as ink jet printing and the like. Shown is paper sheet 27 passing through a first binder application station 30. Station 30 includes a nip formed by a smooth rubber press roll 32 and a patterned rotogravure roll 33. Rotogravure roll 33 is in communication with a reservoir 35 containing a first binder 38. Rotogravure roll 33 applies the binder 38 to one side of sheet 27 in a pre-selected pattern.

Sheet 27 is then contacted with a heated roll 40 after passing a roll 41. The heated roll 40 is for partially drying the sheet after the application of the binder. The heated roll 40 can be heated to a temperature, for instance, up to about 250° F. (121° C.) and, more particularly, from about 180° F. to about 220° F. (82° C. to about 104° C.). In general, the sheet can be heated to a temperature sufficient to dry the sheet and evaporate any water. It should be understood, that the besides the heated roll 40, any suitable heating device can be used to dry the sheet. For example, in an alternative embodiment, the sheet can be placed in communication with an infra-red heater in order to dry the sheet. Besides using a heated roll or an infra-red heater, other heating devices can include, for instance, any suitable convective oven or microwave oven.

From the heated roll 40, the sheet 27 can be advanced by pull rolls 43A and 43B to a second binder application station 45. Station 45 includes a transfer roll 47 in contact with a rotogravure roll 48, which is in communication with a reservoir 49 containing a second binder 50, which can be the same or different than the binder 38 applied at the first station 30. Similar to station 30, the second binder 50 is applied to the opposite side of the sheet in a pre-selected pattern. After the second binder is applied, the sheet is adhered to a creping roll 55 by a press roll 56. The sheet is carried on the surface of the creping roll for a distance and then removed therefrom by the action of a creping blade 58. The creping blade performs a controlled pattern creping operation on the second side of the sheet.

Once creped, the sheet 27 is pulled through an optional drying station 60. The drying station can include any form of a heating unit, such as an oven energized by infrared heat, microwave energy, hot air or the like. Alternatively, the drying station may comprise other drying methods such as photo-curing, UV-curing, corona discharge treatment, electron beam curing, curing with reactive gas, curing with heated air such as through-air heating or impingement jet heating, infrared heating, contact heating, inductive heating, microwave or RF heating, and the like. The drying station may be necessary in some applications to dry the sheet and/or cure the binder materials. Depending upon the binder selected, however, drying station 60 may not be needed. Once passed through the drying station, the sheet can be wound into a roll of material or product 65.

FIG. 2B is similar to FIG. 2A, except that both sides of the sheet are creped. More specifically, creping drum 55 with creping blade 58 is substituted for heated roll 40.

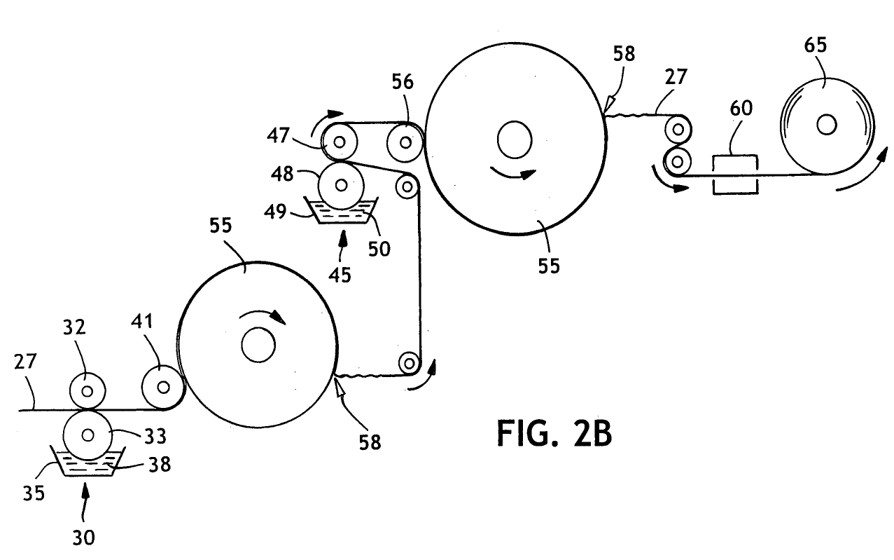

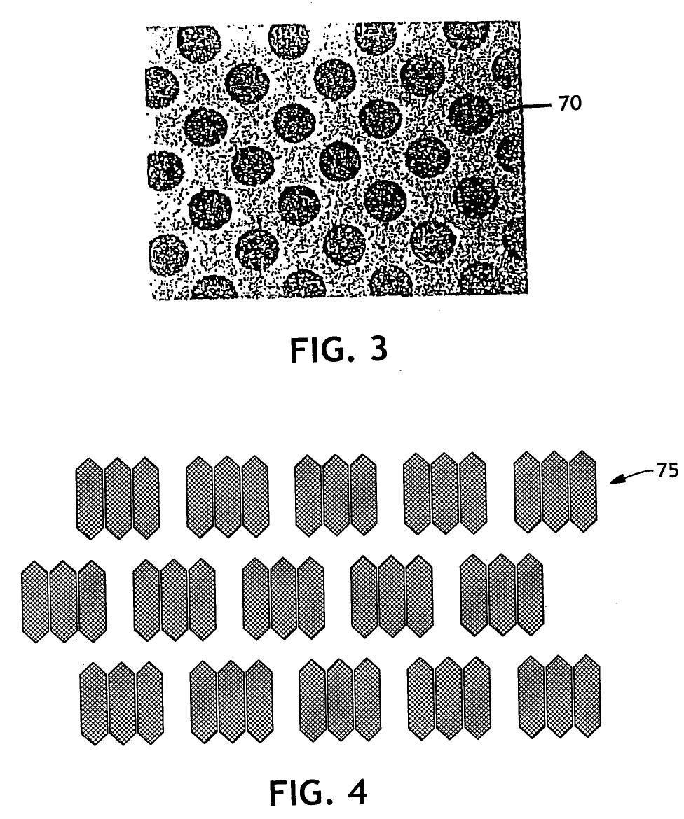

FIG. 3 shows one embodiment of a print pattern that can be used for applying a binder to a paper sheet in accordance with this invention. As illustrated, the pattern represents a succession of discrete dots 70. In one embodiment, for instance, the dots can be spaced so that there are approximately from about 25 to about 35 dots per inch (25.4 mm) in the machine direction and/or the cross-machine direction. The dots can have a diameter, for example, of from about 0.01 inch (0.25 mm) to about 0.03 inch (0.76 mm). In one particular embodiment, the dots can have a diameter of about 0.02 inch (0.51 mm) and can be present in the pattern so that approximately 28 dots per inch (25.4 mm) extend in either the machine direction or the cross-machine direction. Besides dots, various other discrete shapes such as elongated ovals or rectangles can also be used when printing the binder onto the sheet. For example, as shown in FIG. 4, a print pattern is illustrated in which the binder print pattern is made up of discrete multiple deposits 75 that are each comprised of three elongated hexagons. In one embodiment, each hexagon can be about 0.02 inch (0.51 mm) long and can have a width of about 0.006 inch (0.15 mm). Approximately 35 to 40 deposits per inch (25.4 mm) can be spaced in the machine direction and the cross-machine direction.

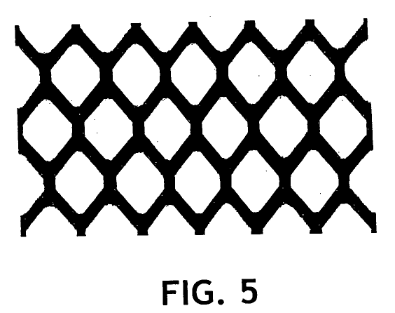

FIG. 5 illustrates an alternative binder pattern in which the binder is printed onto the sheet in a reticulated pattern. The dimensions are similar to those of the dot pattern of FIG. 3. Reticulated patterns, which provide a continuous network of binder, may result in relatively greater sheet strength than comparable patterns of discrete elements, such as the dot pattern of FIG. 3.

### EXAMPLES

### Example 1

A pilot tissue machine was used to produce a layered, uncreped throughdried towel basesheet in accordance with this invention generally as described in FIG. 1. After manufacture on the tissue machine, the uncreped throughdried basesheet was printed on each side with a latex binder. The binder-treated sheet was adhered to the surface of a Yankee dryer to re-dry the sheet and thereafter the sheet was creped. The resulting sheet was converted into rolls of single-ply paper towels in a conventional manner.

More specifically, the basesheet was made from a stratified fiber furnish containing a center layer of fibers positioned between two outer layers of fibers. Both outer layers of the basesheet contained 100% northern softwood kraft pulp and about 1.5 kilograms (kg)/metric ton (Mton) of dry fiber of a debonding agent (ProSoft® TQ1003 from Hercules, Inc.). Each of the outer layers comprised 25% of the total fiber weight of the sheet. The center layer, which comprised 50% of the total fiber weight of the sheet, was comprised of 100% by weight of northern softwood kraft pulp. The fiber in this layer was also treated with 1.5 kg/Mton of ProSoft® TQ1003 debonder.

The machine-chest furnish containing the chemical additives was diluted to approximately 0.2 percent consistency and delivered to a layered headbox. The forming fabric speed was approximately 1265 feet per minute (fpm) (386 meters per minute). The basesheet was then rush transferred to a transfer fabric (Voith Fabrics, t1207-6) traveling 10% slower than the forming fabric using a vacuum roll to assist the transfer. At a second vacuum-assisted transfer, the basesheet was transferred and wet-molded onto the throughdrying fabric (Voith Fabrics, t1203-1). The sheet was dried with a through-air-dryer resulting in a basesheet having an air-dry basis weight of 58.8 grams per square meter (gsm).

The resulting sheet was fed to a gravure printing line as shown in FIG. 2A where the latex binder was printed onto the surface of the sheet. The first side of the sheet was printed with a binder formulation using direct rotogravure printing. The sheet was printed with a 0.020 inch (0.51 mm) diameter “dot” pattern as shown in FIG. 3 wherein 28 dots per inch (25.4 mm) were printed on the sheet in both the machine and cross-machine directions. The resulting surface area coverage was approximately 25%. Then the printed sheet passed over a heated roll to evaporate water.

Next, the second or opposite side of the sheet was printed with the same latex binder formulation using a second direct rotogravure printer. The sheet was printed with discrete shapes, where each shape was comprised of three elongated hexagons as illustrated in FIG. 4. Each hexagon within each discrete shape was approximately 0.02 inch (0.51 mm) long with a width of about 0.006 inch (0.15 mm). The hexagons within a discrete shape were essentially in contact with each other and aligned in the machine direction. The spacing between discrete shapes was approximately the width of one hexagon. The sheet was printed with 40 discrete shapes per inch (25.4 mm) in the machine direction and 40 elements per inch (25.4 mm) in the cross-machine direction. The resulting surface area coverage was approximately 50%. Of the total latex binder material applied, roughly 60% was applied to the first side and 40% to the second side of the web, even though the surface area coverage of the second side was greater than that of the first side. This arrangement provided for greater penetration of the binder material into the sheet by the first pattern than the second pattern, which remained substantially on the surface of the second side of the sheet.

The sheet was then pressed against and creped off a rotating drum, which had a surface temperature of 52° C. Finally the sheet was dried and the binder material cured using air heated to 260° C. and wound into a roll. Thereafter, the resulting print/print/creped sheet was converted into rolls of single-ply paper toweling in a conventional manner. The finished product had an air dry basis weight of 69.2 gsm.

The latex binder material in this example was a vinyl acetate ethylene copolymer, Airflex® EN1165, which was obtained from Air Products and Chemicals, Inc. of Allentown, Pa. The add-on amount of the binder applied to the sheet was approximately 7 weight percent.

The binder formulation contained the following ingredients:

| | |
|---|---|
| 1. Airflex ® EN1165 (52% solids) | 10,500 g |
| 2. Defoamer (Nalco 94PA093) | 54 g |
| 3. Water | 3,000 g |
| 4. Catalyst (10% NH₄Cl) | 545 g |
| 5. Thickener (2% Natrosol 250MR, Hercules) | 1,100 g |

For this example, the properties of wet CD tensile strength, wet CD stretch, wet CD TEA, wet CD slope, dry CD slope and GMT are shown in Table 1. Other product properties are shown in Table 2.

### Example 2

A single-ply towel was produced as described in Example 1, except both outer layers and the center layer of the basesheet contained about 4.5 kg/Mton of dry fiber of a debonding agent (ProSoft™ TQ1003 from Hercules, Inc.), the basesheet was transferred and wet-molded onto the 934 throughdrying fabric (from Voith Fabrics), resulting in a basesheet having an air-dry basis weight of 59.2 gsm. The sheet was then subjected to the print/print/crepe process per example 1. Thereafter, the resulting print/print/creped sheet was converted into rolls of single-ply paper toweling in a conventional manner. The finished product had an air dry basis weight of 71.8 gsm.

For this example, the properties of wet CD tensile strength, wet CD stretch, wet CD TEA, wet CD slope, dry CD slope and GMT are shown in Table 1. Other product properties are shown in Table 2.

### Example 3

A single-ply towel was produced as described in Example 1, except the forming fabric speed was approximately 1438 fpm (438 meters per minute), the basesheet was then rush transferred to a transfer fabric (Voith Fabrics, 2164) traveling 25% slower than the forming fabric using a vacuum roll to assist the transfer, the basesheet was then transferred and wet-molded onto the 934 throughdrying fabric (from Voith Fabrics), resulting in a basesheet having an air-dry basis weight of 58.9 gsm. The sheet was then subjected to the printiprinticrepe process per example 1. Thereafter, the resulting printiprinticreped sheet was converted into rolls of single-ply paper toweling in a conventional manner. The finished product had an air dry basis weight of 69.2 gsm.

For this example, the properties of wet CD tensile strength, wet CD stretch, wet CD TEA, wet CD slope, dry CD slope and GMT are shown in Table 1. Other product properties are shown in Table 2.

### Example 4

A single-ply towel was produced as described in Example 1, except both outer layers and the center layer of the basesheet contained about 4.5 kg/Mton of dry fiber of a debonding agent (ProSoft™ TQ1003 from Hercules, Inc.),the basesheet was then rush transferred to a transfer fabric (Voith Fabrics, 2164) traveling 10% slower than the forming fabric using a vacuum roll to assist the transfer, the basesheet was then transferred and wet-molded onto the 934 throughdrying fabric (from Voith Fabrics), resulting in a basesheet having an air-dry basis weight of 56.9 gsm. The sheet was then subjected to the print/print/crepe process per example 1. Thereafter, the resulting print/print/creped sheet was converted into rolls of single-ply paper toweling in a conventional manner. The finished product had an air dry basis weight of 67.3 gsm.

For this example, the properties of wet CD tensile strength, wet CD stretch, wet CD TEA, wet CD slope, dry CD slope and GMT are shown in Table 1. Other product properties are shown in Table 2.

### Example 5

A pilot tissue machine was used to produce a layered, uncreped throughdried towel basesheet in accordance with this invention generally as described in FIG. 1. After manufacture on the tissue machine, the uncreped throughdried basesheet was printed on each side with a latex binder (moisture barrier coating). The binder-treated sheet was adhered to the surface of a Yankee dryer to re-dry the sheet and thereafter the sheet was creped. The resulting sheet was converted into rolls of single-ply paper towels in a conventional manner.

More specifically,.the basesheet was made from a stratified fiber furnish containing a center layer of fibers positioned between two outer layers of fibers. Both outer layers of the basesheet contained 100% northern softwood kraft pulp and about 4.5 kg/Mton of dry fiber of a debonding agent (ProSoft™ TQ1003 from Hercules, Inc.). Each of the outer layers comprised 25% of the total fiber weight of the sheet. The center layer, which comprised 50% of the total fiber weight of the sheet, was comprised of 100% by weight of northern softwood kraft pulp. The fiber in this layer was also treated with 4.5 kg/Mton of ProSoft™ TQ1003 debonder.

The machine-chest furnish containing the chemical additives was diluted to approximately 0.2 percent consistency and delivered to a layered headbox. The forming fabric speed was approximately 1265 fpm (386 meters per minute). The basesheet was then rush transferred to a transfer fabric (Voith Fabrics, 2164) traveling 10% slower than the forming fabric using a vacuum roll to assist the transfer. At a second vacuum-assisted transfer, the basesheet was transferred and wet-molded onto the throughdrying fabric (Voith Fabrics, t1203-1). The sheet was dried with a through air dryer resulting in a basesheet having an air-dry basis weight of 57.2 gsm.

The resulting sheet was fed to a gravure printing line as shown in FIG. 2B where the latex binder was printed onto the surface of the sheet. The first side of the sheet was printed with a binder formulation using direct rotogravure printing. The sheet was printed with a 0.020 inch (0.51 mm) diameter “dot” pattern as shown in FIG. 3 wherein 28 dots per inch (25.4 mm) were printed on the sheet in both the machine and cross-machine directions. The resulting surface area coverage was approximately 25%. The printed sheet was then pressed against and creped off a rotating drum, which had a surface temperature of 104° C.

Next, the second or opposite side of the sheet was printed with the same latex binder formulation using a second direct rotogravure printer. The sheet was printed with discrete shapes, where each shape was comprised of three elongated hexagons as illustrated in FIG. 4. Each hexagon within each discrete shape was approximately 0.02 inch (0.51 mm) long with a width of about 0.006 inch (0.15 mm). The hexagons within a discrete shape were essentially in contact with each other and aligned in the machine direction. The spacing between discrete shapes was approximately the width of one hexagon. The sheet was printed with 40 discrete shapes per inch (25.4 mm) in the machine direction and 40 elements per inch (25.4 mm) in the cross-machine direction. The resulting surface area coverage was approximately 50%. Of the total latex binder material applied, roughly 60% was applied to the first side and 40% to the second side of the web, even though the surface area coverage of the second side was greater than that of the first side. This arrangement provided for greater penetration of the binder material into the sheet by the first pattern than the second pattern, which remained substantially on the surface of the second side of the sheet.

The sheet was then pressed against and creped off a rotating drum, which had a surface temperature of 104° C. Finally the sheet was dried and the binder material cured using air heated to 260° C. and wound into a roll. Thereafter, the resulting print/creped/printcreped sheet was converted into rolls of single-ply paper toweling in a conventional manner. The finished product had an air dry basis weight of 68.6 gsm.

The latex binder material in this example was a vinyl acetate ethylene copolymer, Airflex® EN1165, which was obtained from Air Products and Chemicals, Inc. of Allentown, Pa. The add-on amount of the binder applied to the sheet was approximately 7 weight percent.

The binder formulation contained the following ingredients:

| | |
|---|---|
| 6. Airflex ® EN1165 (52% solids) | 10,500 g |
| 7. Defoamer (Nalco 94PA093) | 54 g |
| 8. Water | 3,000 g |
| 9. Catalyst (10% NH₄Cl) | 545 g |
| 10. Thickener (2% Natrosol 250MR, Hercules) | 1,100 g |

For this example, the properties of wet CD tensile strength, wet CD stretch, wet CD TEA, wet CD slope, dry CD slope and GMT are shown in Table 1. Other product properties are shown in Table 2.

### Example 6

A single-ply towel was produced as described in Example 5, except the basesheet was rush transferred to a transfer fabric (Voith Fabrics, t1207-6) and then transferred and wet-molded onto the 934 throughdrying fabric (from Voith Fabrics), resulting in a basesheet having an air-dry basis weight of 58.5 gsm. The sheet was then subjected to the print/crepe/printicrepe process per example 5. Thereafter, the resulting print/creped/print/creped sheet was converted into rolls of single-ply paper toweling in a conventional manner. The finished product had an air dry basis weight of 68.6 gsm.

For this example, the properties of wet CD tensile strength, wet CD stretch, wet CD TEA, wet CD slope, dry CD slope and GMT are shown in Table 1. Other product properties are shown in Table 2.

### Example 7

A single-ply towel was produced as described in Example 5, except the forming fabric speed was approximately 1438 fpm (438 meters per minute), the basesheet was then rush transferred to a transfer fabric (Voith Fabrics, t1207-6) traveling 25% slower than the forming fabric, the basesheet was then transferred and wet-molded onto the 934 throughdrying fabric (from Voith Fabrics), resulting in a basesheet having an air-dry basis weight of 58.7 gsm. The sheet was then subjected to the print/crepe/print/crepe process per example 5. Thereafter, the resulting print/creped/print/creped sheet was converted into rolls of single-ply paper toweling in a conventional manner. The finished product had an air dry basis weight of 67.6 gsm.

For this example, the properties of wet CD tensile strength, wet CD stretch, wet CD TEA, wet CD slope, dry CD slope and GMT are shown in Table 1. Other product properties are shown in Table 2.

### Example 8

A single-ply towel was produced as described in Example 5, except both outer layers and the ceriter layer of the basesheet contained about 1.5 kg/Mton of dry fiber of a debonding agent (ProSoft® TQ1003 from Hercules, Inc.), and the basesheet transferred and wet-molded onto the 934 throughdrying fabric (from Voith Fabrics), resulting in a basesheet having an air-dry basis weight of 58.2 gsm. The sheet was then subjected to the print/crepe/print/crepe process per example 5. Thereafter, the resulting print/creped/print/creped sheet was converted into rolls of single-ply paper toweling in a conventional manner. The finished product had an air dry basis weight of 68.1 gsm.

For this example, the properties of wet CD tensile strength, wet CD stretch, wet CD TEA, wet CD slope, dry CD slope and GMT are shown in Table 1. Other product properties are shown in Table 2.

### Example 9

A single-ply towel was produced as described in Example 5, except the basesheet was transferred and wet-molded onto the 934 throughdrying fabric (from Voith Fabrics), resulting in a basesheet having an air-dry basis weight of 58.4 gsm. The sheet was then subjected to the print/crepe/print/crepe process per example 5. Thereafter, the resulting print/creped/print/creped sheet was converted into rolls of single-ply paper toweling in a conventional manner. The finished product had an air dry basis weight of 69.1 gsm.

For this example, the properties of wet CD tensile strength, wet CD stretch, wet CD TEA, wet CD slope, dry CD slope and GMT are shown in Table 1. Other product properties are shown in Table 2.

TABLE 1

| | Example 1 | Example 2 | Example 3 | Example 4 |
|---|---|---|---|---|
| Debonder | 1.5 | 4.5 | 1.5 | 4.5 |
| Addition | | | | |
| (kg/Mton) | | | | |
| Transfer | t1207-6 | t1207-6 | 2164 | 2164 |
| Fabric | | | | |
| Rush | 10% | 10% | 25% | 10% |
| Transfer | | | | |
| TAD Fabric | t1203-1 | 934 | 934 | 934 |
| Treatment | Print/Print/Crepe | Print/Print/Crepe | Print/Print/Crepe | Print/Print/Crepe |
| CD Wet | 968 | 857 | 736 | 928 |
| Tensile | | | | |
| (grams/76.2 mm) | | | | |
| CD Wet | 14.8 | 15.8 | 15.2 | 14.4 |
| Stretch (%) | | | | |
| CD Wet | 12.3 | 11.9 | 11.9 | 13.3 |
| TEA (gram | | | | |
| cm/cm²) | | | | |
| CD Wet | 4.9 | 4.2 | 4.4 | 5.4 |
| Slope | | | | |
| (kg/76.2 mm) | | | | |
| CD Slope | 7.8 | 5.3 | 9.6 | 8.0 |
| (kg/76.2 mm) | | | | |
| GMT | 1649 | 1444 | 1898 | 1763 |
| (grams/76.2 mm) | | | | |
| Basis | 69.2 | 71.8 | 69.2 | 67.3 |
| Weight, as | | | | |
| is (gsm) | | | | |
| CD Wet per | 14.0 | 11.9 | 10.6 | 13.8 |
| unit as is | | | | |
| Basis | | | | |
| Weight | | | | |

| | Example 5 | Example 6 | Example 7 | Example 8 | Example 9 |
|---|---|---|---|---|---|
| Debonder | 4.5 | 4.5 | 4.5 | 1.5 | 4.5 |
| Addition | | | | | |
| (kg/Mton) | | | | | |
| Transfer Fabric | 2164 | t1207-6 | t1207-6 | 2164 | 2164 |
| Rush Transfer | 10% | 10% | 25% | 10% | 10% |
| TAD Fabric | t1203-1 | 934 | 934 | 934 | 934 |
| Treatment | Print/Crepe/ | Print/Crepe/ | Print/Crepe/ | Print/Crepe/ | Print/Crepe/ |
| | Print/Crepe | Print/Crepe | Print/Crepe | Print/Crepe | Print/Crepe |
| CD Wet Tensile | 977 | 880 | 787 | 1009 | 779 |
| (grams/76.2 mm) | | | | | |
| CD Wet Stretch | 17.5 | 17.7 | 18.8 | 17.3 | 17.2 |
| (%) | | | | | |
| CD Wet TEA | 14.0 | 14.0 | 13.3 | 17.9 | 12.4 |
| (gram cm/cm²) | | | | | |
| CD Wet Slope | 3.9 | 3.8 | 3.6 | 5.1 | 3.9 |
| (kg/76.2 mm) | | | | | |
| CD Slope | 5.6 | 4.9 | 4.7 | 6.5 | 5.9 |
| (kg/76.2 mm) | | | | | |
| GMT | 1638 | 1524 | 1550 | 1805 | 1584 |
| (grams/76.2 mm) | | | | | |
| Basis Weight, as | 68.6 | 68.6 | 67.6 | 68.1 | 69.1 |
| is (gsm) | | | | | |
| CD Wet per unit | 14.3 | 12.8 | 11.6 | 14.8 | 11.3 |
| as is Basis | | | | | |
| Weight | | | | | |

| | | Bounty | | | Sparkle | Sparkle | |
|---|---|---|---|---|---|---|---|
| | | Best | | | Paper | Paper | Example 1 |
| | | Ever | VIVA ® | Brawny | Towels | Towels | from |
| | | Paper | Paper | Paper | (Big | (Regular | U.S. Pat. No. |
| | Comparative* | Towels | Towels | Towels | Roll) | Roll) | 6,129,815 |
| CD Wet | 970 | 763 | 786 | 858 | 760 | 670 | 468 |
| Tensile | | | | | | | |
| (grams/76.2 mm) | | | | | | | |
| CD Wet | 12.9 | 8.9 | 14.4 | 4.2 | 3.6 | 3.3 | Not |
| Stretch (%) | | | | | | | recorded |
| CD Wet TEA | 11.2 | 6.0 | 10.5 | 4.1 | 3.2 | 2.6 | Not |
| (gram | | | | | | | recorded |
| cm/cm²) | | | | | | | |
| CD Wet | 5.6 | 6.6 | 4.5 | 17.2 | 20.6 | 20.1 | Not |
| Slope | | | | | | | recorded |
| (kg/76.2 mm) | | | | | | | |
| CD Slope | 7.6 | 15.6 | 6.0 | 43.4 | 42.7 | 35.6 | Not |
| (kg/76.2 mm) | | | | | | | recorded |
| GMT | 1615 | 2566 | 1425 | 2997 | 3349 | 3211 | Not |
| (grams/76.2 mm) | | | | | | | recorded |
| Basis Weight, | 71.2 | 40.8 | 67.6 | 48.3 | 50.1 | 49.8 | 48.7 |
| as is (gsm) | | | | | | | (presumed |
| | | | | | | | as is) |
| CD Wet per | 13.6 | 18.7 | 11.6 | 17.8 | 15.2 | 13.4 | 9.6 |
| unit as is | | | | | | | |
| Basis Weight | | | | | | | |

*Note: The Comparative sample is Example 5 of commonly-assigned co-pending U.S. Patent Application Ser. No. 10/654,286 filed Sep. 2, 2003 in the name of Hermans et al. and entitled “Paper Sheet Having High Absorbent Capacity and Delayed Wet Out”.

TABLE 2

| | Example 1 | Example 2 | Example 3 | Example 4 |
|---|---|---|---|---|
| MD Tensile (grams/76.2 mm) | 1893 | 1852 | 2594 | 2326 |
| MD Stretch (%) | 27.3 | 30.1 | 36.3 | 19.3 |
| MD Slope (kg/76.2 mm) | 5.1 | 3.1 | 4.6 | 9.3 |
| MD TEA (g cm/cm²) | 35.3 | 31.8 | 55.5 | 32.6 |
| CD Tensile (grams/76.2 mm) | 1437 | 1126 | 1388 | 1337 |
| CD Stretch (%) | 16.4 | 20.3 | 19.6 | 17.1 |
| CD TEA (g cm/cm²) | 22.2 | 22.3 | 29.1 | 25.0 |
| MD/CD Tensile Ratio | 1.32 | 1.64 | 1.87 | 1.74 |
| Caliper (inches) | 0.0339 | 0.0381 | 0.0279 | 0.029 |
| 10-Sheet Caliper/10 (micrometers) | 798 | 884 | 644 | 685 |
| Stack Bulk (cc/gram) | 11.5 | 12.3 | 9.3 | 10.2 |
| Dry Burst (grams) | 771 | 709 | 746 | 782 |

| | Example 5 | Example 6 | Example 7 | Example 8 | Example 9 |
|---|---|---|---|---|---|
| MD Tensile (grams/76.2 mm) | 1972 | 2146 | 2216 | 2615 | 2206 |
| MD Stretch (%) | 22.4 | 21.7 | 32.4 | 21.0 | 20.8 |
| MD Slope (kg/76.2 mm) | 4.9 | 5.3 | 2.8 | 6.7 | 5.5 |
| MD TEA (g cm/cm²) | 29.2 | 32.0 | 39.0 | 35.9 | 30.2 |
| CD Tensile (grams/76.2 mm) | 1361 | 1082 | 1084 | 1246 | 1137 |
| CD Stretch (%) | 18.7 | 19.2 | 21.9 | 19.9 | 18.9 |
| CD TEA (g cm/cm²) | 25.9 | 20.9 | 24.5 | 25.5 | 24.2 |
| MD/CD Tensile Ratio | 1.45 | 1.98 | 2.04 | 2.10 | 1.94 |
| Caliper (inches) | 0.0306 | 0.0306 | 0.0274 | 0.0289 | 0.0295 |
| 10-Sheet Caliper/10 (micrometers) | 741 | 748 | 663 | 694 | 719 |
| Stack Bulk (cc/gram) | 10.8 | 10.9 | 9.8 | 10.2 | 10.4 |
| Dry Burst (grams) | 874 | 723 | 731 | 970 | 769 |

| | | Bounty | | Sparkle | Sparkle |
|---|---|---|---|---|---|
| | | Best | | Paper | Paper |
| | | Ever | VIVA ® | Towels | Towels |
| | | Paper | Paper | (Big | (Regular |
| | Comparative | Towels | Towels | Roll) | Roll) |
| MD Tensile (grams/76.2 mm) | 1763 | 2976 | 1828 | 3558 | 3715 |
| MD Stretch (%) | 33.6 | 16.2 | 22.2 | 15.3 | 12.9 |
| MD Slope (kg/76.2 mm) | 3.7 | 16.1 | 5.3 | 25.8 | 25.8 |
| MD TEA (g cm/cm²) | 39.8 | 38.4 | 29.3 | 42.6 | 34.9 |
| CD Tensile (grams/76.2 mm) | 1480 | 2213 | 1111 | 3152 | 2776 |
| CD Stretch (%) | 16.5 | 12.7 | 17.2 | 5.6 | 5.5 |
| CD TEA (g cm/cm²) | 23.9 | 25.5 | 19.6 | 15.5 | 13.5 |
| MD/CD Tensile Ratio | 1.19 | 1.34 | 1.65 | 1.13 | 1.34 |
| Caliper (inches) | 0.0317 | 0.0249 | 0.028 | 0.0204 | 0.0245 |
| 10-Sheet Caliper/10 (micrometers) | 762 | 592 | 643 | 483 | 569 |
| Stack Bulk (cc/gram) | 10.7 | 14.5 | 9.5 | 9.6 | 11.4 |
| Dry Burst (grams) | 589 | Not | Not | Not | Not |
| | | Tested | Tested | Tested | Tested |

In the interests of brevity and conciseness, any ranges of values set forth-in this specification are to be construed as written description support for claims reciting any sub-ranges having endpoints which are whole number values within the specified range in question. By way of a hypothetical illustrative example, a disclosure in this specification of a range of from 1 to 5 shall be considered to support claims to any of the following sub-ranges: 1-4; 1-3; 1-2; 2-5; 2-4; 2-3; 3-5; 3-4; and 4-5.

It will be appreciated that the foregoing examples, given for purposes of illustration, are not to be construed as limiting the scope of this invention, which is defined by the following claims and all equivalents thereto.

We claim:

1. A soft durable paper towel having a wet CD TEA of about 12 g-cm/cm² or greater and a wet CD Slope of about 5 kilograms or less.

2. The paper towel of claim 1 wherein the wet CD TEA is about 13 g-cm/cm² or greater.

3. The paper towel of claim 1 wherein the wet CD TEA is about 14 g-cm/cm² or greater.

4. The paper towel of claim 1 wherein the wet CD TEA is from about 12 to about 18 g-cm/cm².

5. The paper towel of claim 1 wherein the wet CD TEA is from about 12 to about 14 g-cm/cm².

6. The paper towel of claim 1 wherein the wet CD Slope is about 4 kilograms or less.

7. The paper towel of claim 1 wherein the wet CD Slope is about 3 kilograms or less.

8. The paper towel of claim 1 wherein the wet CD Slope is from about 1 to about 5 kilograms.

9. The paper towel of claim 1 wherein the wet CD Slope is from about 1 to about 4 kilograms.

10. The paper towel of claim 1 wherein the dry CD Slope is about 6 kilograms or less.

11. The paper towel of claim 1 wherein the wet CD tensile strength is about 700 grams or greater.

12. The paper towel of claim 1 having a wet CD stretch of about 14 percent or greater.

13. The paper towel of claim 1 having a GMT of about 1900 grams or less.

14. A method of making a paper towel sheet comprising:
(a) depositing an aqueous suspension of papermaking fibers onto a forming fabric to form a layered web having two outer layers and one or more inner layers, the inner layer(s) of the web containing from about 1 to about 10 kilograms of a chemical debonding agent per ton of fiber;
(b) rush-transferring the web from the forming fabric to a transfer fabric;
(c) transferring the web from the transfer fabric to a throughdrying fabric;
(d) throughdrying the web to a final dryness of from about 1 to about 5 percent moisture;
(e) feeding the resulting sheet to a gravure printing line wherein a binder is printed onto one outer surface of the sheet;
(f) printing a binder onto the other outer surface of the sheet;
(g) pressing the sheet against a rotating creping drum with a presser roll such that the sheet does not adhere to the presser roll;
(h) creping the sheet from the creping drum; and
(i) converting the sheet into a paper towel.

15. The method of claim 14 wherein the web is rush-transferred from the forming fabric to the transfer fabric at a speed differential of from about 5 to about 45 percent.

16. The method of claim 14 wherein the surface area coverage of the binder on both outer surfaces of the sheet is from about 10 to about 70 percent.

17. The method of claim 14 wherein the add-on amount of binder is about 2 weight percent or greater.
